(19) United States
(12) Patent Application Publication
(10) Pub. No.: US 2018/0184040 A1
(43) Pub. Date: Jun. 28, 2018

(54) DISPLAY APPARATUS AND DISPLAYING METHOD

(71) Applicant: SAMSUNG ELECTRONICS CO., LTD., Suwon-si (KR)

(72) Inventors: Nak-won CHOI, Gwangmyeong-si (KR); Jin-hyuk HONG, Seoul (KR); Young-kwang SEO, Suwon-si (KR); Eun-seok CHOI, Suwon-si (KR)

(73) Assignee: SAMSUNG ELECTRONICS CO., LTD., Suwon-si (KR)

(21) Appl. No.: 15/852,691

(22) Filed: Dec. 22, 2017

(30) Foreign Application Priority Data
Dec. 23, 2016 (KR) 10-2016-0178439

(51) Int. Cl. H04N 5/58; H04N 5/64; H04N 5/14

(52) U.S. Cl. CPC H04N 5/58; H04N 5/144; H04N 5/64

(57) ABSTRACT

A display apparatus and display method thereof is provided. The display apparatus comprises a display configured to display an image, an image sensor configured to be disposed at a rear side of the display, a reflection member configured to reflect light incident on a front side of the display apparatus and to form an image on the image sensor, and a processor configured to control an operation of the display apparatus based on an image captured in the image sensor.

### CROSS-REFERENCE TO RELATED APPLICATIONS

This application claims priority from Korean Patent Application No. 10-2016-0178439, filed on Dec. 23, 2016 in the Korean Intellectual Property Office, the disclosure of which is incorporated herein by reference in its entirety.

### BACKGROUND OF THE INVENTION

### Field of the Invention

Apparatuses and methods consistent with one or more exemplary embodiments relate to a display apparatus and a displaying method, and more particularly, to the display apparatus which may sense the movement of a user by using a sensor which is minimally exposed, and a displaying method.

### Description of the Prior Art

A display apparatus processes and displays digital or analogue image signals received from an external, or various image signals stored as compressed files in various formats in an internal storage.

The recent display apparatus includes an image sensor, confirms the movement of a user and the like using the image captured in the image sensor, and controls various display apparatuses according to the confirmed movement.

However, in the related art, the image sensor is disposed at the area near a bezel of the display apparatus in order to sense the user who is at the front side of the display apparatus. Accordingly, there has been a limitation in reducing the size of the bezel of the display apparatus, and there has been a problem that the design is poor because of an exposure of a lens.

### SUMMARY OF THE INVENTION

Accordingly, the purpose of an exemplary embodiment is to provide the display apparatus which may sense the movement of a user using the sensor which is minimally exposed, and a displaying method.

According to an exemplary embodiment, there is provided a display apparatus including a display, an image sensor configured to be disposed at a rear side of the display, a reflection member configured to reflect light incident on a front side of the display apparatus and to form an image on the image sensor, and a processor configured to control an operation of the display apparatus based on the image formed on the image sensor.

In this case, the reflection member may be a waveguide in which a cross section of a pipe is positioned on the image sensor, and another cross section of the pipe is positioned along a front direction of the display apparatus.

The waveguide may be made of a transparent material.

The reflection member may include a reflector configured to reflect light, and a guide member configured to fix a position of the reflector so that light incident on the front side of the display apparatus forms the image on the image sensor.

The image sensor may be disposed along a lower direction or an upper direction of the display at the rear side of the display, and the reflection member may be disposed along a lower direction or an upper direction of the display relative to the image sensor, and the reflection member is disposed in a form in which only a partial area of the reflection member is exposed in the front side of the display apparatus.

The processor may control an operation of the display apparatus by using only a preset area of the image formed on the image sensor.

The processor may confirm an area corresponding to a front side of the display apparatus in the image formed on the image sensor, and set the confirmed area as a preset area.

The processor may confirm a user gesture based on the image formed on the image sensor, and perform an event corresponding to the confirmed user gesture.

The processor may control the display to display a background image corresponding to a rear side of the display, and the processor may confirm surrounding environment information in the captured image, and control the display to display a shadow object together with the background image based on the confirmed surrounding environment information.

According to an exemplary embodiment, there is provided a displaying method including generating an image captured by using a reflection member which reflects light incident from an image sensor disposed at the rear side of the display from a front side of the display apparatus, and forming the image on the image sensor, and controlling an operation of the display by using the generated image.

The controlling may control an operation of the display apparatus by using only a preset area of the image captured in the image sensor.

The displaying method may further include confirming an area corresponding to a front side of the display apparatus in the image captured in the image sensor, and setting the confirmed area as a preset area.

The controlling may confirm a user gesture based on the captured image and performs an event corresponding to the confirmed user gesture.

The displaying may display a background image corresponding to a background of the rear side of the display.

The displaying method may further include confirming surrounding environment information in the captured image, and displaying a shadow object based on the confirmed surrounding environment information.

### BRIEF DESCRIPTION OF THE DRAWINGS

FIG. 1 is a view illustrating an exemplary embodiment in which a display provides an image effect such that the display becomes a transparent window, according to an exemplary embodiment;

FIG. 2 is a block diagram illustrating a brief composition of a display apparatus according to an exemplary embodiment;

FIG. 3 is a block diagram illustrating a detailed composition of a display apparatus according to an exemplary embodiment;

FIG. 4 is a view illustrating the detailed composition of an image processor of FIG. 2;

FIGS. 5A and 5B are views illustrating a detailed configuration of a reflection member according to an exemplary embodiment;

FIG. 6 is a view illustrating a case in which a reflection member is realized using a reflector and a guide member;

FIG. 7 is a view illustrating various examples of placements in which a reflection member may be placed;

FIG. 8 is a view illustrating a method for processing an image obtained through a reflection member;

FIGS. 9A, 9B and 9C are views illustrating various examples of active areas according to an assembly tolerance of a reflection member;

FIGS. 10A, 10B and 10C are views illustrating a method for setting an active area based on a position of a user; and

FIG. 11 is a flowchart illustrating a displaying method according to an exemplary embodiment.

### DETAILED DESCRIPTION

The present disclosure may have several embodiments, and the embodiments may be modified variously. In the following description, specific embodiments are provided with accompanying drawings and detailed descriptions thereof. However, this does not necessarily limit the scope of the exemplary embodiments to a specific embodiment form. Instead, modifications, equivalents and replacements included in the disclosed concept and technical scope of this specification may be employed. In describing the exemplary embodiments, well-known functions or constructions are not described in detail since they would obscure the specification with unnecessary detail.

The terms such as “first,” “second,” and so on may be used to describe a variety of elements, but the elements should not be limited by these terms. The terms are used simply to distinguish one element from other elements.

The terms used herein are solely intended to explain a specific exemplary embodiment, and not to limit the scope of the present disclosure. Singular forms are intended to include plural forms unless the context clearly indicates otherwise. The singular expression also includes the plural meaning as long as it does not differently mean in the context. The terms, “include”, “comprise”, “is configured to”, etc. of the description are used to indicate that there are features, numbers, steps, operations, elements, parts or combination thereof, and they should not exclude the possibilities of combination or addition of one or more features, numbers, steps, operations, elements, parts or combination thereof.

In the embodiments disclosed herein, a term ‘module’ or ‘unit’ refers to an element that performs at least one function or operation. The ‘module’ or ‘unit’ may be realized as hardware, software, or combinations thereof. In addition, a plurality of ‘modules’ or a plurality of ‘units’ may be integrated into at least one module and may be realized as at least one processor (not illustrated) except for ‘modules’ or ‘units’ that should be realized in a specific hardware.

Example embodiments are described below in greater detail with reference to the accompanying drawings.

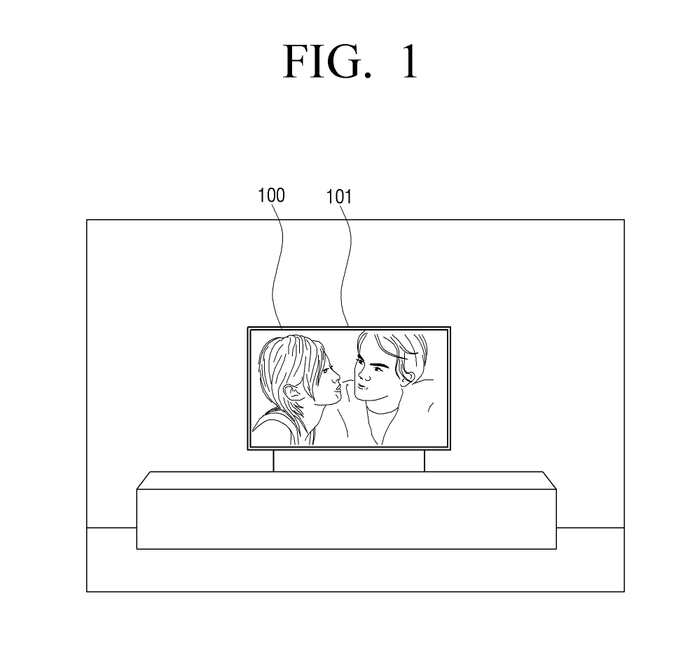

FIG. 1 is a view illustrating an operation of a display apparatus according to an exemplary embodiment.

The display apparatus 100 may display an image. The display apparatus 100 may sense the environment of the front side of the display apparatus 100 and perform various operations according to the sensed environment.

For example, the display apparatus 100 may detect the lighting direction, lighting intensity and the like surrounding the display apparatus and perform an image process with respect to the brightness of a backlight and the displayed object.

The display apparatus 100 may perform an image process for improving a viewing angle if a user is positioned at the area other than the front side of the display apparatus.

In addition, if a user is not sensed, the display apparatus 100 may stop the operation for displaying an image.

In order to perform the above mentioned operations, the sensor such as an image sensor etc. has to be disposed in the display apparatus. In the related art, the image sensor is disposed at a bezel 101 area of the display apparatus because the front side of the display apparatus has to be sensed.

However, in order for the display apparatus 100 to be disposed in harmony with the surrounding environment or for an aesthetic purpose, it is desirable that the display apparatus has no bezel or the bezel has a minimum area.

It is difficult to reduce the size of the bezel because a sensor has to be disposed on the bezel in order for an image sensor to be disposed at the front side of the display apparatus, and thus the bezel is not harmonized with the surrounding environment.

Accordingly, in the exemplary embodiment, the sensor is not disposed at the front side of the display in which the bezel is disposed. The sensor is disposed at the rear side of the display, and the light of the front side of the display forms an image on the image sensor by using a reflection member.

According to the structure of the sensor, it becomes difficult to recognize the sensor at the front side of the display apparatus. In addition, the reflection member may be realized in a transparent waveguide, and in this case, the great effect may occur in the design because the sensor may become more difficult to be recognized.

In the following description, the above operation will be described in further detail with reference to specific components of the display apparatus.

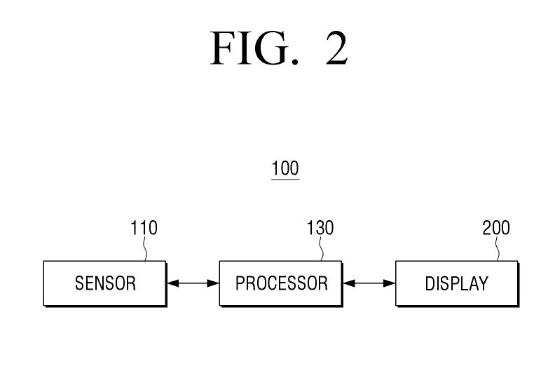

FIG. 2 is a block diagram illustrating a brief composition of a display apparatus according to an exemplary embodiment.

Referring to FIG. 2, the display apparatus 100 may be composed of a sensor 110, a processor 130, and a display 200.

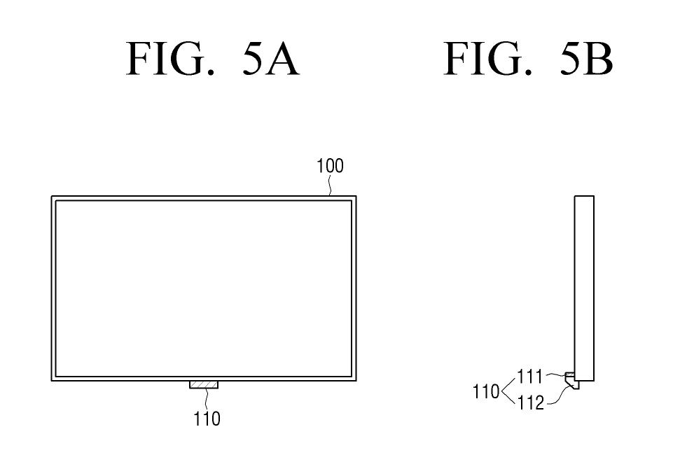

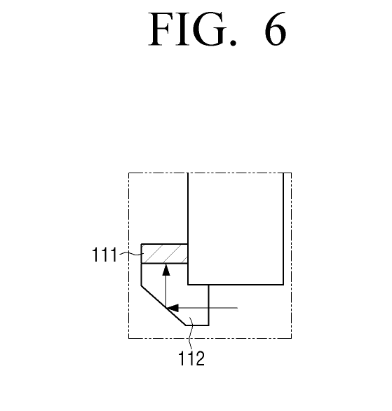

The sensor 110 may sense a user's position. Specifically, the sensor 110 may sense whether a user presents at the front side of the display apparatus 100 or the position of the user. For this, the sensor 110 is composed of an image sensor such as complementary metal oxide semiconductor (CMOS) and a charge coupled device (CCD) disposed at the rear side of the display, and a reflection member which reflects the light of the front side of the display and forms an image on the image sensor. Specific constitution and operation of the sensor 110 will be described below by referring to FIGS. 5A, 5B and 6.

The sensor 110 may sense the movement of a user or a distance to the user based on the captured image.

The sensor 110 may sense the lighting environment of the surrounding area of the display apparatus. For sensing the lighting environment, the sensor 110 may include a plurality of sensors disposed at the positions spaced apart from each other on the display apparatus. In this case, the plurality of sensors may be the illumination sensors which sense illumination intensity, and may be the color sensors which sense color temperature and the like in addition to the illumination intensity. Meanwhile, the illumination sensor and the color sensor described above may be embedded in the frame of the display apparatus not to be influenced by the light emitted from the display 200.

The sensor 110 may sense the lighting environment surrounding the display apparatus 100. Specifically, the sensor 110 may sense the color temperature, illumination intensity and the like from the image captured through the image sensor. In addition, the sensor 110 may sense the lighting environment by using the illumination sensor, the color sensor and the like in addition to the image sensor. For example, the sensor 110 may include a plurality of illumination sensors disposed at the positions placed apart from each other on the display apparatus, and sense the lighting direction. Here, the illumination sensor is the sensor which senses the illumination intensity, and one of the illumination sensors may be a color sensor which may sense the color temperature and the like in addition to the illumination intensity. The sensors described above may be embedded in the frame of the display apparatus so as not to be influenced by the light emitted from the display 200.

The sensor 110 may further include an IR sensor, an ultrasonic sensor, an RF sensor and the like, and sense if a user presents and the position of the user.

The display 200 may display an image. The display 200 may be realized as various types of displays, such as a Liquid Crystal Display (LCD), a Plasma Display Panel (PDP), and so on. The display 200 may further include a driver circuit that may be realized in the form such as an amorphous-silicon Thin Film Transistor (a-si TFT), Low Temperature Poly Silicon (LTPS), Thin Film Transistor (TFT), organic TFT (OTFT), and the like, and a backlight unit etc. The display 200 may be realized as a touch screen in combination with a touch sensor.

The display 200 may include a backlight. Here, the backlight may be a point light source consisting of a plurality of light sources. The backlight supports local dimming.

Here, the light source composing the backlight may be composed of a Cold Cathode Fluorescent Lamp (CCFL) or a Light Emitting Diode (LED). In the following description, the backlight consists of the LED and an LED driver circuit, but the backlight may consist of other compositions other than the LED in the implementation. The plurality of light sources composing the backlight may be arranged in various forms, and diverse local dimming methods may be applied thereto. For example, the backlight may be the backlight of direct type in which a plurality of light sources are disposed in a matrix form evenly on the entire crystal liquid screen. In this case, the backlight may operate as Full-Array local dimming or as the direct local dimming. The Full-Array local dimming refers to a dimming method in which the light sources are arranged evenly behind the LCD screen, and the brightness is adjusted for each light source. The direct local dimming is similar to the Full-Array local dimming, but the brightness is adjusted for each light source for the fewer number of light sources.

Further, the backlight may be a backlight of an edge type which is composed of one light source or in which the plurality of light sources are arranged only on an edge portion of the LCD. In this case, the backlight may operate as Edge-lit local dimming. In case of the Edge-lit local dimming, the plurality of light sources may be arranged on only an edge portion, only left/right portions, only upper/lower portions, or only left/right/upper/lower portions of a panel.

The processor 130 may control overall operations of the display apparatus 100. For example, the processor 130 may determine the operation mode of the display apparatus 100. Specifically, if the processor 130 received a TV display command or a content display command from a user, the processor 130 may determine the mode as a first operation mode in which a general image is displayed.

Here, the first operation mode is the operation status in which a general image is displayed, and a second operation mode to be described below is the operation status in which the display apparatus 100 displays the background image of the rear side of the display apparatus 100, not the general image.

If a power command or a switching command of the operation mode is received in the first operation mode, the processor 130 may determine that the mode is the second operation mode in which a background is displayed. Accordingly, the first and the second operation modes may be switched according to the general power operation of a user in an exemplary embodiment.

If a user pushes a power button for a preset time while the display apparatus 100 operates in the first operation mode or the second operation mode, the processor 130 may change the mode into the general power off mode.

If the power command is received in the power off mode, the processor 130 may determine to operate in the operation mode right before the power off.

If the operation mode of the display apparatus 100 is determined to be the first operation mode, the processor 130 may control the display 200 to display the image according to the control command received through an operator 175.

Here, the processor 130 may generate a plurality of dimming signals corresponding to the brightness value of the displayed image, and provide the generated signals to the display 200. Here, the processor 130 may adjust the brightness of the displayed image considering the brightness value of an external by using only one among the brightness values sensed in the plurality of sensors in the sensor 110.

If the operation mode of the display apparatus 100 is determined to be the second operation mode, the processor 130 may control the display 200 to display a background image.

In addition, the processor 130 may control the sensor 110 to sense the lighting environment surrounding the display apparatus 100, and determine the direction of the lighting and the brightness of the lighting according to the sensed lighting environment.

The processor 130 may perform an image process with respect to the background image to be displayed according to the sensed lighting environment (that is, the direction or the brightness of the lighting). Specifically, the processor 130 may perform the image process for changing the color temperature of the background image based on the color temperature sensed in the sensor 110.

The processor 130 may control the display 200 to display an object when displaying the background image. Specifically, the processor 130 may generate the screen including the background image and the preset object, and provide the generated screen to the display 200. Here, the preset object may be an analogue watch, a digital watch and the like, and may be various graphic objects such as a picture, a photo, a fish bowl and the like. The graphic object may be a static graphic object such as a picture and a photo, and may be an operation object.

In addition, the processor 130 may determine the lighting direction according to the sensed lighting environment, and control the display to display a shadow object with regard to the object at the position corresponding to the determined lighting direction.

In addition, the processor 130 may determine the size of the shadow object according to the sensed lighting value and the color temperature, and control the display to display the shadow object having the determined size. For example, the shadow may vary according to the lighting intensity or the color temperature of the lighting.

Accordingly, the display apparatus 100 according to the exemplary embodiment may generate and display the shadow object considering the lighting intensity and the color temperature.

In order to save power, the processor 130 may display a background image only when a user is sensed in the surrounding area of the display apparatus 100 by an infrared sensor and the like, when operating in the second operation mode. That is, the processor 130 may not display the background image if a user is not sensed in the surrounding area of the display apparatus 100 when operating in the second operation mode.

In the second operation mode, the processor 130 may control the display 200 to operate in the lower frame rate than the frame rate of the first operation mode. For example, if the display 200 displays an image in 240 Hz in the first operation mode, the processor 130 may control the display 200 to operate in 120 Hz or 60 Hz which are slower than 240 Hz, in the second operation mode.

In addition, if a user is not sensed through the sensor 110, the processor 130 may control the display 200 not to perform a display operation of an image.

Based on the weather information received from a communicator 170 to be described later, the processor 130 may let the corresponding object to be displayed, or perform a specific event. For example, if rain information is sensed in the weather information, the processor 130 may control the display 200 to display a rain object on the background, and control the audio output unit 155 to output the sound of rain.

The processor 130 may perform a control operation according to the user motion recognized by the sensor 110. That is, the display apparatus 100 may operate in a motion control mode. When operating in the motion control mode, the processor 130 may photograph a user by activating the sensor 110, track the change in the user motion, and perform a controlling operation corresponding thereto.

For example, in the display apparatus 100 that supports a motion control mode, a motion recognition technology may be used in the above-described various exemplary embodiments. For example, if the user makes a motion as if the user is selecting an object displayed on a home screen, or states a voice command that corresponds to the object, it is determined that the corresponding object is selected and the control operation that matches the object may be performed.

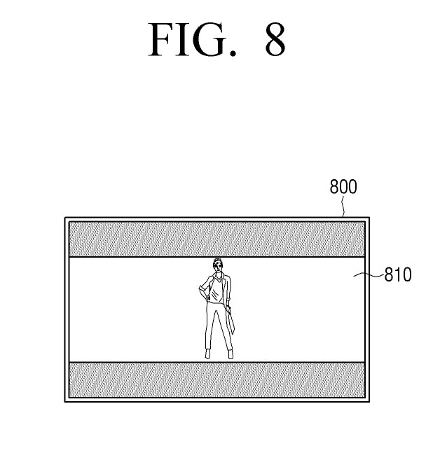

Here, the processor 130 may perform an image analysis by using only the preset area of the image transmitted from the sensor 110. Here, the preset area is the area which defines the active area in the image transmitted from the sensor 110. The preset area may be already preset when the display apparatus is released, and may be set through the test process after an installation. This operation will be described below with reference to FIG. 8.

As described above, the display apparatus 100 may display the background at an empty area shown while a main image is displayed, and thus the immersion of the main image may be enlarged.

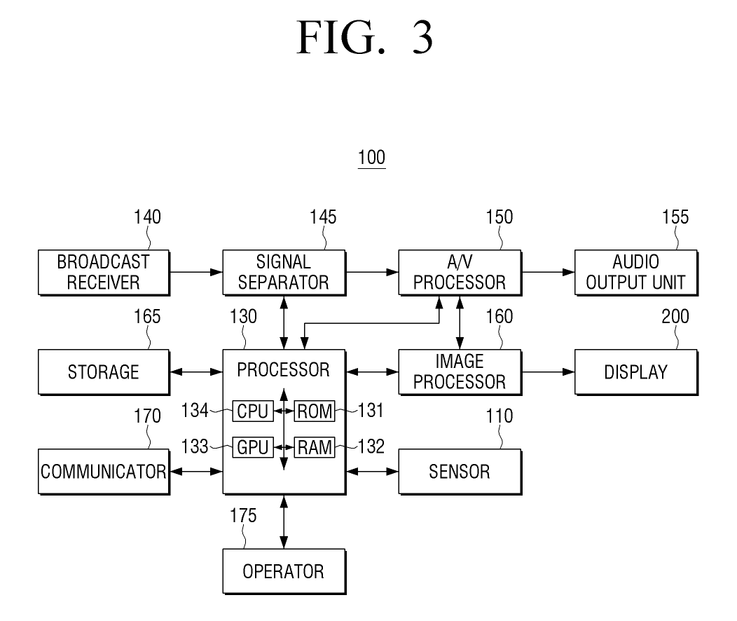

In the above, merely the simple configuration of the display apparatus 100 has been described, but the display apparatus 100 may further include the configuration described in FIG. 3. Specific composition of the display apparatus 100 will be described below by referring to FIG. 3.

FIG. 3 is a block diagram illustrating a detailed composition of a display apparatus according to an exemplary embodiment.

Referring to FIG. 3, a display device 100 according to the exemplary embodiment includes the sensor 110, the processor 130, a broadcast receiver 140, a signal separator 145, an audio/video (A/V) processor 150, an image processor 160, an audio output unit 155, a storage 165, a communicator 170, an operator 175, and a display 200.

Since the configuration of the display 200 may be the same as the configuration of FIG. 2, further explanation thereof is omitted.

The broadcast receiver 140 may receive a broadcast from a broadcasting station or from a satellite in a wired and/or wireless manner and demodulate the received broadcast. To be specific, the broadcast receiver 140 may receive a transport stream through an antenna or a cable, demodulate the received transport stream, and output a digital transport stream signal.

The signal separator 145 may divide the transport stream signal received from the broadcast receiver 140 to a video signal, an audio signal, and an additional information signal. Subsequently, the signal separator 145 may transmit the video signal and the audio signal to the A/V processor 150.

The A/V processor 150 may perform signal processing, such as video decoding, video scaling, audio decoding and the like with respect to the video signal and the audio signal that are input from the broadcast receiver 140 and the storage 165. In the exemplary embodiment, it has been described that the video decoding and the video scaling are performed in the A/V processor 150, but the above operation may be performed in the image processor 160. In addition, the A/V processor 150 may output the image signal to the image processor 160 and output the audio signal to the audio output unit 155.

However, if the received video and audio signals are stored in the storage 165, the A/V processor 150 may output the video and audio to the storage 165 in a compressed form.

The audio output unit 155 may convert the audio signal output from the A/V processor 150 to sound and output the converted sound through a speaker (not illustrated) or output the converted sound to an external apparatus connected through an external output terminal (not illustrated).

The image processor 160 may generate a Graphic User Interface (GUI) to be provided to a user. The GUI may be an On Screen Display (OSD), and the image processor 160 may be implemented in a digital signal processor (DSP).

Further, the image processor 160 may add the generated GUI to the image that is output from the A/V processor 150 which will be described below. Further, the image processor 160 may provide the image signal corresponding to the image in which the GUI is added to the display 200. Accordingly, the display 200 may display various kinds of information provided by the display apparatus 100 and the image transferred from the image signal provider 160.

The image processor 160 may receive the background image as one layer (or a main layer), receive the image generated in the A/V processor 150 or the object image provided from the processor 130 as another layer (or a sub layer), and output one of the two layers or synthesis (or mix) two layers and provide the output or synthesized layer to the display 200.

Specifically, the image processor 160 may generate a first layer corresponding to a main image, generate a second layer corresponding to a background image, and if an empty area is confirmed in the first layer, mix the first layer and the second layer by mixing the second layer only in the empty area of the first layer.

Here, the image processor 160 may perform different image processes for each of the input two layers (that is, the main image and the background image), and perform a mixing with respect to the two layers in which different image processes have been performed.

In addition, the image processor 160 may perform a follow-up image quality process with respect to the mixed (or combined) image.

The image processor 160 may obtain the brightness information corresponding to the image signal and generate one dimming signal (if the display apparatus operates as a global dimming) or a plurality of dimming signals (if the display apparatus operates as a local dimming) corresponding to the obtained brightness information. Here, the image signal provider 160 may consider the lighting environment sensed in the sensor 110 and generate the above described dimming signal. This dimming signal may be a pulse width modulation (PWM) signal.

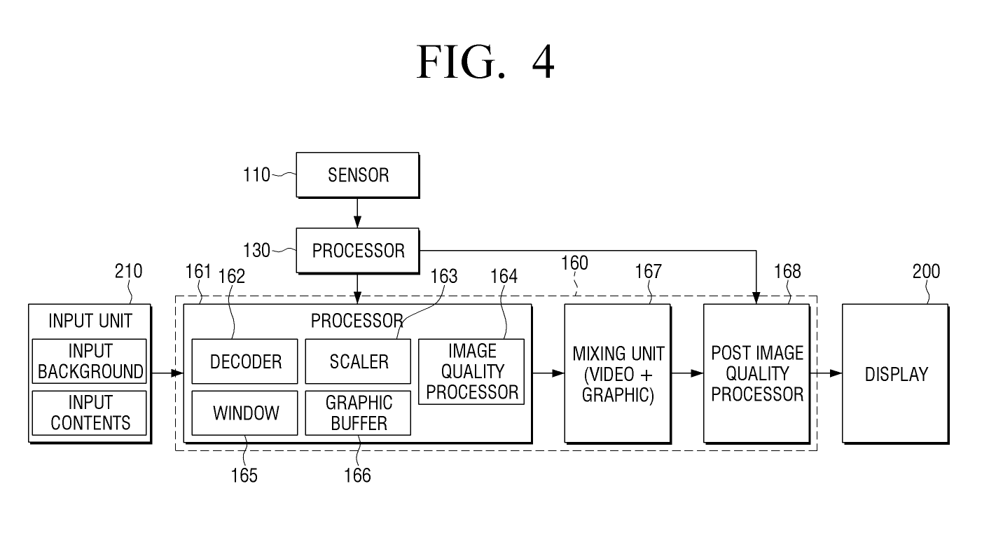

The detailed configuration and operation of the image processor 160 will be described later with reference to FIG. 4.

The storage 165 may store an image content. Specifically, the storage 165 may receive and store the image content in which a video and an audio are compressed, from the A/V processor 150, and may output the stored image content to the A/V processor 150 under the control of the processor 130.

Further, the storage 165 may store the pre-captured or pre-generated background image. In addition, the storage 165 may store the program or contents corresponding to various objects which may be displayed when operating in the second operation mode. The storage 165 may store a plurality of lookup tables used in the viewing angle improvement process. The storage 165 may be implemented in a hard disk, nonvolatile memory, volatile memory and the like.

The operator 175 may be realized as a touch screen, a touch pad, a key button, a key pad, and so on, and provide a user manipulation of the display apparatus 100. According to an example embodiment, a control command is received through the operator 175 disposed in the display apparatus 100, but the operator 175 may receive the user manipulation from the external control apparatus (e.g., a remote controller).

The communicator 170 may communicate with various external apparatuses according to various types of communication methods. The communicator 170 may include a Wireless-Fidelity (Wi-Fi) chip 331 and a Bluetooth chip 332. The processor 130 may perform a communication with various external devices by using the communicator 170. Specifically, the communicator 170 may receive a control command from the control terminal apparatus which may control the display apparatus 100 (e.g., a remote controller).

The communicator 170 may acquire weather information through the communication with an external server.

Although not illustrated in FIG. 2, the communicator 170 may further include a Universal Serial Bus (USB) port to which a USB connector may be connected, diverse external input ports to be connected to various external terminals such as a headset, a mouse, or Local Area Network (LAN), or a Digital Multimedia Broadcasting (DMB) chip for receiving and processing a DMB signal, according to an example embodiment.

The processor 130 controls overall operations of the display apparatus 100. To be specific, in the first operating mode, the processor 130 may control the image processor 160 and the display 200 to display an image according to a control command received through the operator 175.

If the change command with regard to one of the size and position of a main image is received through the operator 175, the processor 130 may control the display 200 to change and display at least one of the size and position of the displayed main image based on the input change command. Here, the change command may include a ratio change.

The processor 130 may include a Read-Only Memory (ROM) 131, a Random Access Memory (RAM) 132, a graphic processing unit (GPU) 133, a Central Processing Unit (CPU) 134, and a bus. The ROM 131, the RAM 132, the GPU 133, and the CPU 134 may be connected to each other through the bus.

The CPU 134 may access the storage 175 to perform a booting using an operating system (O/S) stored in the storage 175. The CPU 134 may perform various operations using various programs, contents, data, etc. that are stored in the storage 175. The operations of the CPU 134 have been described above in connection with the processor 130 in FIG. 2, and thus the explanation thereof will be omitted.

The ROM 131 may store a set of commands for system booting. If a turn-on command is input and thus power is applied, the CPU 134 may copy the O/S stored in the storage 165 to the RAM 132 according to the commands stored in the ROM 131 and may execute the O/S to boot the system. When the booting is completed, the CPU 134 copies various programs stored in the storage 165 to the RAM 132 and executes the programs copied to the RAM 132 to perform various operations.

Upon completion of the boot-up operation of the display apparatus 100, the GPU 133 may generate the screen including various objects, such as icons, images, text, or the like. To be specific, in response to the electronic apparatus 100 operating in the second operation mode, the GPU 133 may generate the screen including the preset object in the background image. In addition, the GPU 133 may generate the screen including the shadow object corresponding to the displayed object and/or the shadow object corresponding to the frame of the display apparatus 100.

The GPU may be composed of a separate composition such as the image processor 160, or realized as a SoC in combination with a CPU in the processor 130.

As described above, the display apparatus 100 may sense a user using the sensor 110 of which only some area is exposed in the front direction, and thus the lens which is not aesthetically pleasing may not be exposed. Accordingly, the bezel of the display apparatus may be formed in the smaller size.

FIG. 4 is a view illustrating the detailed composition of an image processor of FIG. 2.

Referring to FIG. 4, the image processor 160 may be composed of the processor 161, a mixing unit 167, and a post image quality processor 168.

The processor 161 may perform an image processing with regard to a plurality of video signals. Specifically, the processor 161 may perform image processes with regard to a plurality of layers concurrently. The processor 161 may be composed of a decoder 162, a scaler 163, an image quality processor 164, a window 165, and a graphic buffer 166.

First, the processor 161 may identify whether the attribute of the input image is a video signal or a graphic signal, and if the attribute of the input image is a video signal, process the image using the decoder 162, the scaler 163, and the image quality processor 164. For example, if the image having a video attribute is input to the processor 161 through an input unit 210, the decoder 162 may decode the input video image and the scaler 163 may scale the decoded video image, the image quality processor 164 may perform an image quality process with regard to the video image and output the processed video image to the mixing unit 167. Here, the image having the video attribute may be the image input from an external source or the image of the video content pre-stored in the display apparatus.

If the attribute of the input image is a graphic signal, the image is processed with the window 165 and the graphic buffer 166. For example, if the object image having the graphic attribute (e.g., a game image, a background image, or an object) is input through the input unit 210, the processor 161 may ladder the graphic signal to the graphic buffer 166 through the window 165 and output the image generated in the buffer 166 to the mixing unit 167.

As described above, since the processor 161 may process a plurality of images, a plurality of layers may be processed. It has been described that different sorts of two signals are processed, but in the implementation, two video signals may be processed respectively by using a plurality of layers, and two graphic signals may be processed respectively by using a plurality of layers, by the processor 161. In addition, more than three layers, not two layers, may be used in the processing.

The image quality processor 164 may perform a variety of image processing to improve the image quality with respect to the image according to the graphic signal, in addition to the image according to the video signal. Here, the image processing may be an improvement of a viewing angle, an adjustment of a white balance, a removal of a noise and the like.

The mixing unit 167 may mix two images transmitted from the processor 161 into one.

The post image quality processor 168 may perform an image quality process (W/B) with respect to the mixed image and transmit the processed image to the display 200.

FIGS. 5A and 5B are views illustrating a detailed configuration of a reflection member according to an exemplary embodiment.

Referring to FIG. 5A, the sensor 110 is disposed at the bottom when being seen in the front side of the display apparatus 110. Specifically, the sensor 110 may be disposed in the bottom direction and some part thereof is exposed.

The sensor 110 may be composed of an image sensor 111 and a reflection member 112.

The image sensor 111 may generate an image or a video by capturing the image formed on the lens with an image sensing device such as CCD and CMOS. The image sensor 111 may be disposed at the rear side of the display apparatus 100 in the direction looking at a floor.

In addition, the reflection member 112 may reflect the light incident from the front side of the display apparatus and form an image on an image sensor. The reflection member 112 may be composed of a waveguide or a reflector and a guide member.

Here, the waveguide is a transmission line to transmit electric energy or a signal along an axis. In the exemplary embodiment, a light waveguide (a light pipe or an optical waveguide) may be used. The light waveguide is a circuit or a track which transmits the light signal, and may be an optic fiber or a thin film waveguide.

In the case in which the reflection member 112 is implemented in the light waveguide, the cross section of a pipe of the waveguide is positioned on the image sensor, and another cross section of the pipe is positioned in the front direction of the display apparatus. Since the cross section of the light waveguide is smaller than the cross section of the lens of the image sensor, the size exposed in the front of the display apparatus 100 may be smaller than the size of the lens of the existing image sensor.

In addition, the light waveguide is composed of a transparent material, and thus it is difficult for a user to recognize the cross section of the light waveguide exposed in small size.

In this case, the light of the front side of the display apparatus 100 may form an image on the image sensor 111 through the pipe of the light waveguide. Here, the light which forms an image on the image sensor 111 may be captured as a video image, and the captured image is transmitted to the processor 130.

Meanwhile, the image sensor 110 in the exemplary embodiment captures the front side of the display apparatus 100 not directly but through the reflection member 112, and thus the left/right direction of the formed image may be opposite to the left/right direction of the front image. Accordingly, in the implementation, if the image processing in the related art is used, the image captured in the image sensor 110 may be used by switching the left/right direction.

The image sensor 110 in the exemplary embodiment is captured through the reflection member 112, and thus a vignetting may occur by the reflection member 112 with respect to the captured image. If a user's gesture and the like are sensed by using the image in which the vignetting occurs, a lot of resources may be consumed in the image processing. Thus, in the exemplary embodiment, the image processing may be performed by preliminarily excluding the area in which the vignetting occurs. This operation will be described in detail with reference to FIG. 8.

In illustrating FIG. 5A, it has been described that the sensor 110 has relatively big size in the display apparatus 100, but this is for convenience of explanation, and the width and the size of the sensor in the display apparatus which is larger than 30 inches have much smaller ratio than the ratio of the illustrated drawing, and thus it is difficult for a user to recognize the sensor.

In addition, in FIG. 5B, it has been described that the sensor 110 is somewhat protruded to the rear side of the display apparatus 100, but this is for convenience of explanation. In the implementation, the sensor 110 may be less protruded than the bracket to fix the display apparatus 100 on a wall or the standing member for standing the display apparatus 100.

FIG. 6 is a view illustrating the case in which a reflection member is realized using a reflector and a guide member.

Referring to FIG. 6, the image sensor 111 may be disposed at the rear side of the display and in the lower direction of the display.

The reflector is the member which reflects light, and may be a mirror and the like. As illustrated, the reflector may reflect the light of the front side of the display to the image sensor 111 at the upper side, at 45 degrees. In the illustrated example, merely the mirror is mentioned as an example, but other configurations which may reflect light may be used besides the mirror.

The guide member may fix the reflector and the image sensor configurations so that the reflector reflects light at 45 degrees. The reflector may correspond to the ratio of the image sensor 111. For example, if the horizontal to vertical ratio of the image sensor is 4:3, the reflector may also have 4:3 ratio, and thus the vignetting effect according to the reflection member may be minimized.

In the above, it has been described that only one reflector is used, but in the implementation, the reflection member may be realized using a plurality of reflectors. For example, the image sensor may be disposed in the opposite direction to the display, one reflector may reflect the light of the front side of the display to the upper portion of the display, and the second reflector may reflect the light which is reflected to the upper direction of the display to the image sensor attached to the rear side of the display.

In the above, it has been described that the sensor 110 is disposed at the lower area of the display apparatus, but the position of the sensor is not limited thereto.

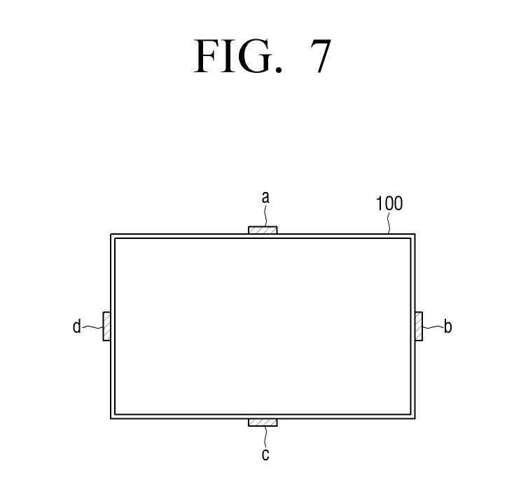

This will be described hereinafter with reference to FIG. 7.

FIG. 7 is a view illustrating various examples of the placements in which a reflection member may be placed.

Referring to FIG. 7, the reflection member 112 may be disposed at the upper portion (a), lower portion (c), left side (d), and right side (b).

However, the gesture recognition and the like may be performed by using the image captured through the sensor 110, and thus for this, it is preferred that the reflection member is disposed in the center area of the display apparatus. For example, it is preferred that the reflection member is disposed at the upper portion (a) or at the lower portion (c).

If the reflection member is disposed at the lower area of the display apparatus 100, a shade may be made by the display, and thus it may be advantageous that the reflection member is disposed at the upper portion (a) of the display apparatus.

In the example illustrated above, it has been illustrated that only one sensor is disposed, but in the implementation, a plurality of sensors may be disposed in a plurality of positions. In this case, the plurality of sensors may be disposed on different sides of the display apparatus 100, or may be disposed on one side.

According to an exemplary embodiment, an image sensor in the sensor 110 is not directly exposed to an external environment, but the sensor 110 may receive light through the reflection member. Accordingly, some part of the image captured according to the effect of the reflection member may not be the image corresponding to the front side of the display apparatus. This will be described hereinafter with reference to FIG. 8.

FIG. 8 is a view illustrating a method for processing an image obtained through a reflection member.

Referring to FIG. 8, the image 800 captured in the image sensor may include a front area 810 corresponding to the front side of the display apparatus and the useless area.

Accordingly, in the case in which the processor 130 uses the image generated in the image sensor, a lot of resources are needed. In this regard, in the exemplary embodiment, the gesture may be sensed using only the preset area (that is, an active area) in the captured image.

The preset area may use the value measured through the experiment in the factory in the product releasing process, and may be set through the test operation of a user after installing the product.

Specifically, the preset area may be set by that the test image is captured by the sensor by using a jig in the factory and by analyzing the captured image.

After installing the product, the message instructing the user to place the paper in which the preset pattern is drawn (e.g., a black paper or a white paper in which a black quadrangle is drawn) in the exposed area of the reflection member is displayed, and the part in which the corresponding pattern is seen is tracked. Subsequently, let the user to move the paper in which the pattern is drawn to the closer area of the exposed area of the reflection member, or acquire the user to move the paper to rear/front, left/right, and up/down directions, and the area in which the corresponding pattern is sensed may be set as a preset area.

In the above, the method for setting the preset area by using the pattern has been used, but the preset area may be confirmed in other methods.

In illustrating FIG. 8, it has been described that the useless area is disposed in the upper portion or the lower portion of the image, but in the implementation, the useless area may be at the left side or at the rear side of the image.

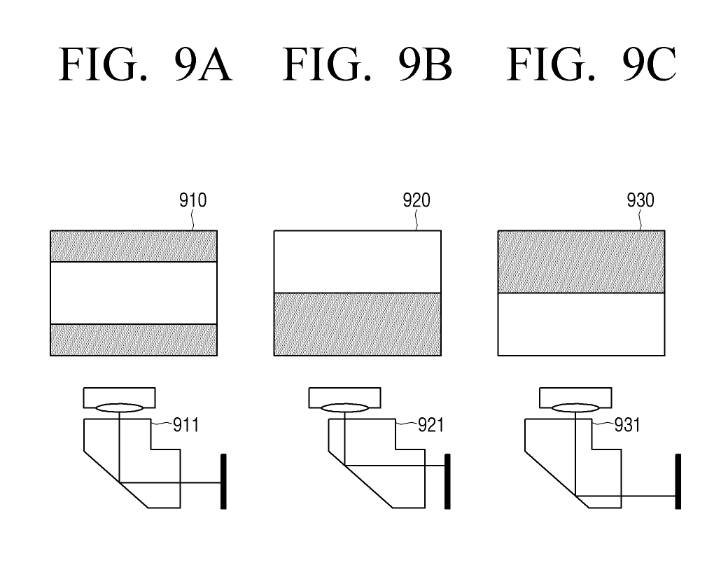

FIGS. 9A, 9B and 9C are views illustrating various examples of active areas according to an assembly tolerance of a reflection member.

Referring to FIG. 9A, if the image sensor and the reflection member 911 are disposed at an accurate position, the active area 910 may be positioned at the center of the captured image as illustrated in the drawing.

However, if the image sensor and the reflection members 921 and 931 are disposed in a twisted manner due to assembly tolerance or the like, for example as illustrated in FIGS. 9B and 9C, the active areas 920 and 930 may be tilted upward or downward, respectively.

As in the above, since the active area is not fixed and may be changed, the process for setting the active area may be performed through the method as described above.

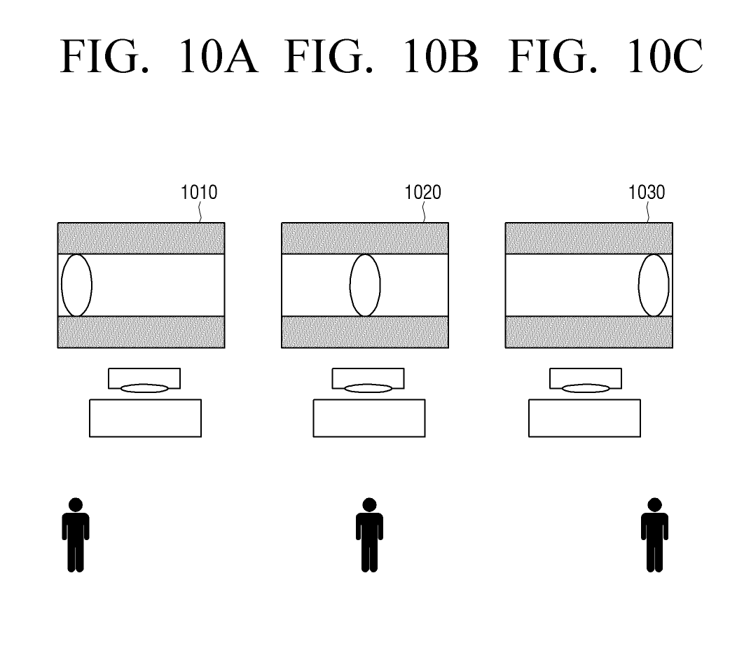

In FIG. 8, it has been illustrated that the active area is set by capturing a specific pattern, but in the implementation, the active area may be set by capturing a user. This will be described hereinafter with reference to FIGS. 10A, 10B and 10C.

FIGS. 10A, 10B and 10C are views illustrating a method for setting the active area based on the position of a user.

Referring to FIGS. 10A, 10B and 10C, the display apparatus 100 may display the message instructing a user to move from the front side to the left/right side of the display apparatus.

Accordingly, if the user moves from the left to the right, the sensor 110 may capture a plurality of images 1010, 1020, and 1030 as shown below, and the processor 130 may set the active area by setting only the area in which the user is captured in the captured plurality of images.

If the active area is set through the method described above, the processor 130 may sense the user's gesture and the like only with the preset area of the input image (that is, the active area). Accordingly, since the useless area is not used, the user's gesture may be sensed with the low resources.

Although it has been described that if the active area is set, the processor 130 uses only the active area of the image, in the implementation, the processor 130 may transmit the active area to the sensor 110 and the sensor 110 may generated the captured image by using only the sensing value in the active area. In this case, the processor 130 may sense the gesture by using the image transmitted from the sensor.

Although it has been described that the active area is detected through the exposure of a pattern or the movement of a user, in the implementation, the area in which a color exists is sensed by using only the image processing with regard to the captured image, and the area in which the color exists may be set as the sensing area.

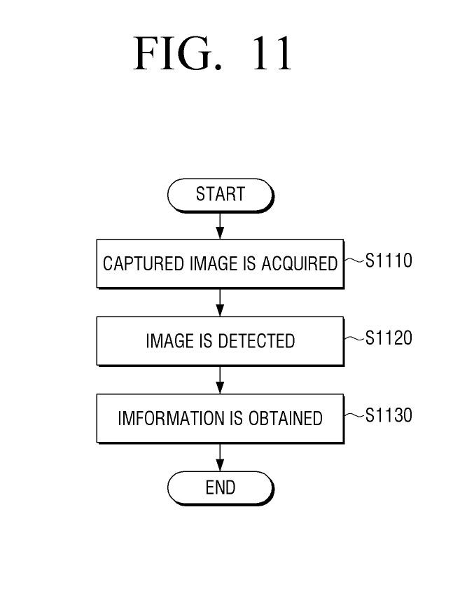

FIG. 11 is a flowchart to illustrate a displaying method according to an exemplary embodiment.

Referring to FIG. 11, an image is displayed by using a display. Here, the displayed image may be the image corresponding to the general content, and may be the background image illustrated with regard to FIG. 1.

In the image displaying process, the captured image is generated by using an image sensor in S1110.

The active area is detected in the generated captured image in S1120, and the operation of the display apparatus may be controlled only with the detected active area in S1130. Specifically, the user's gesture is confirmed in the detected active area, and the event corresponding to the confirmed user's gesture may be performed. If the user's event relates to an image displaying, for example, to a channel change, the image of the changed channel may be displayed.

In addition, if the user is detected in the image captured through the image sensor while the background image is displayed, the operation for displaying the background image consistently may be performed. If the user is not detected for predetermined time while the background image is displayed, the operation of displaying the background image may be stopped.

If the user's position is sensed while the general image is displayed and it is sensed that the user is at the side, not at the front, the viewing angle with respect to the displayed image may be improved and the image of which the viewing angle is improved may be displayed.

As described in the above, since the displaying method according to the exemplary embodiment may sense a user by using the sensor 110 of which some part is exposed in the front direction, the lens exposition which is not aesthetically pleasing may be prevented. Accordingly, the bezel of the display apparatus may be formed in the smaller size. The displaying method as illustrated in FIG. 11 may be performed on the display apparatus having the configuration as illustrated in FIG. 2 or FIG. 3, and may be executed even on a display device having another configuration.

The displaying method according to the above-described exemplary embodiments may be implemented as a program and provided to the display apparatus. In particular, the program including a displaying method according to exemplary embodiments may be stored in a non-transitory computer readable medium and provided therein.

The non-transitory computer readable medium is not a medium that stores data for a short moment such as a register, a cash and a memory and the like, but a medium that stores data semipermanently and which is readable by an apparatus. For example, various applications or programs described above may be stored and provided in the non-transitory computer readable medium such as a compact disk (CD), a digital versatile disk (DVD), a hard disk, a Blu-ray disk, a universal serial bus (USB), a memory card, a read only memory (ROM), or the like, but is not limited thereto.

The foregoing exemplary embodiments and advantages are merely exemplary and are not to be construed as limiting the present disclosure. The present teaching can be readily applied to other types of apparatuses. Also, the description of the exemplary embodiments of the present disclosure is intended to be illustrative, and not to limit the scope of the claims, and many alternatives, modifications, and variations will be apparent to those skilled in the art.

What is claimed is:

1. A display apparatus comprising:
a display;
an image sensor configured to be disposed at a rear side of the display;
a reflection member configured to reflect light incident on a front side of the display apparatus and to form an image on the image sensor; and
a processor configured to control an operation of the display apparatus based on the image formed on the image sensor.

2. The display apparatus as claimed in claim 1, wherein the reflection member is a waveguide in which a cross section of a pipe is positioned on the image sensor, and another cross section of the pipe is positioned along a front direction of the display apparatus.

3. The display apparatus as claimed in claim 2, wherein the waveguide is made of a transparent material.

4. The display apparatus as claimed in claim 1, wherein the reflection member comprises:
a reflector configured to reflect light; and
a guide member configured to fix a position of the reflector so that light incident on the front side of the display apparatus forms the image on the image sensor.

5. The display apparatus as claimed in claim 1, wherein the image sensor is disposed along a lower direction or an upper direction of the display at the rear side of the display, and
wherein the reflection member is disposed along the lower direction or the upper direction of the display relative to the image sensor, and the reflection member is disposed in a form in which only a partial area of the reflection member is exposed in the front side of the display apparatus.

6. The display apparatus as claimed in claim 1, wherein the processor controls the operation of the display apparatus by using only a preset area of the image formed on the image sensor.

7. The display apparatus as claimed in claim 6, wherein the processor confirms an area corresponding to the front side of the display apparatus in the image formed on the image sensor, and sets the confirmed area as a preset area.

8. The display apparatus as claimed in claim 1, wherein the processor confirms a user gesture based on the image formed on the image sensor, and performs an event corresponding to the confirmed user gesture.

9. The display apparatus as claimed in claim 1, wherein the processor controls the display to display a background image corresponding to a rear side of the display, and
wherein the processor confirms surrounding environment information in the image formed on the image sensor, and controls the display to display a shadow object together with the background image based on the confirmed surrounding environment information.

10. A displaying method comprising:
generating an image captured by using a reflection member which reflects light incident on an image sensor that is disposed at a rear side of a display from a front side of the display apparatus;
forming the image on the image sensor; and
controlling an operation of the display by using the generated image.

11. The displaying method as claimed in claim 10, wherein the controlling controls the operation of the display by using only a preset area of the image captured in the image sensor.

12. The displaying method as claimed in claim 11, further comprising:
confirming an area corresponding to the front side of the display in the image captured in the image sensor; and
setting the confirmed area as a preset area.

13. The displaying method as claimed in claim 10, wherein the controlling confirms a user gesture based on the image captured and performs an event corresponding to the confirmed user gesture.

14. The displaying method as claimed in claim 10, the displaying displays a background image corresponding to a background of the rear side of the display.

15. The displaying method as claimed in claim 14, further comprising:
confirming surrounding environment information in the captured image; and
displaying a shadow object based on the confirmed surrounding environment information.

16. The display apparatus as claimed in claim 1, wherein the image sensor indirectly captures the image of an object located at the front side of the display apparatus according to light reflected by the reflection member.
